(19) United States
(12) Patent Application Publication
(10) Pub. No.: US 2007/0110052 A1
(43) Pub. Date: May 17, 2007

(54) System and method for the static routing of data packet streams in an interconnect network

(76) Inventors: Sophana Kok, Voisins Le Bretonneux (FR); Philippe Boucard, Le Chesnay (FR)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/407,391

(22) Filed: Apr. 19, 2006

(30) Foreign Application Priority Data
Nov. 16, 2005 (FR) FR 05 11591

(51) Int. Cl. H04L 12/56

(52) U.S. Cl. 370/389

(57) ABSTRACT

The system for the static routing of streams of data packets in an interconnect network comprises:
at least one sending element (2), one receiving element (3), and one link set (4) of unidirectional communication links linking said sending element (2) to said receiving element (3),
means (9) of detecting a stream identifier of a data packet, and
dynamic routing management means (8), designed to keep the order of output of the data packets of one and the same stream from said receiving element (3) identical to the order of arrival of said packets at said sending element (2).

The present invention relates to a system and a method for the static routing of streams of data packets in an interconnect network.

An interconnect network links a set of agents exchanging data. This data is formatted for transmission in the network using a predefined communication protocol.

The network comprises a set of point-to-point unidirectional links interlinking internal nodes of the network and agents of the network. Each node of the network is capable of receiving information in data form over one or more incoming links, and redirecting it over one or more outgoing links. An information item is therefore contained in a string of bits or octets grouped in the form of data packets.

A link is a set of wires and logic gates for routing data between two elements or agents of the network. The data is transferred in the form of words of defined length, in a defined order. Normally, the data transfers are paced by clock pacing frequencies, one clock pacing frequency in transmission and one clock pacing frequency in reception.

To set up direct links between each pair of agents of the network would be too expensive, so the number of links is limited by creating common data transmission sections in the network. There are dedicated agents for routing or switching the messages circulating on the interconnect network, called switches.

Such networks have a network organization to provide the link between the switches and the other agents, and a routing assembly for circulating the messages within the network organization.

A switch is an active agent of the interconnect network which receives as input messages from one or more agents and which routes each of these messages respectively to their destination agent or to another switch. This routing is performed on the basis of the address of the recipient agent of the message, the address of which is included in the header of the message to be routed. A message is a series of data packets.

At a node of the network, a selection device, or arbitration device, is used to resolve sharing conflicts on these common sections. This selection or arbitration cannot ensure with precision the time of data transfer across the network. The arbitration can be performed on the basis of different criteria, necessarily taking into account the fact that an item of information must never be definitively blocked to avoid a network deadlock.

A data packet can be temporarily blocked at a node of the network, by means of a memory organized as a queue. To prevent the queue from becoming too big, due to temporarily blocked data being stored at a node, flow control can be implemented. Flow control enables a data packet to be transmitted, from a source agent to a recipient agent, only if the recipient agent has indicated, by a signal, that it is ready to receive data.

To implement flow control, it is therefore desirable, for a unidirectional communication link transmitting data from a sending element to a receiving element, to have a unidirectional flow control link for transmitting, from the receiving element to the sending element, a signal indicating that the receiver is ready to receive data.

For an information item to be able to be transmitted between a source agent and a recipient agent, it is essential to set up, at a given instant, a physical path between the source agent and the recipient agent. If each source agent/recipient agent pair has a corresponding predetermined physical path, the routing in the network is said to be “static”.

The term “routing” is used to mean the act of defining a path at a node of the network, that is, of associating an incoming link with an outgoing link.

For a static routing, each node of the network has routing tables which determine, for each incoming link, the outgoing link to which data received via said incoming link must be transmitted, according to the source agent and the recipient agent.

It is therefore necessary for the information representative of the source agent and the recipient agent to be associated with the information to be transmitted.

For optimized bandwidth usage, additional information is associated with a number of words to be transmitted, or data packets.

A packet is normally made up of a header of one or more words, for example containing an address of a source agent and an address of a recipient agent, and a certain number of useful data words. The header of a packet is decoded to obtain information needed to route this packet. A word is made up of a plurality of bits.

When information is transmitted between a source agent and a recipient agent, the information cannot take just any path, because it is essential for certain information to be received in the order in which it was sent.

To maintain the order in a stream of information, without having to reorder the data packets of the stream on arrival, it is essential for all this information to take the same path.

If two information items take different paths through the network, they can be delayed independently of each other, according to the arbitration or selection functions at the nodes they cross, and therefore arrive in any order at the recipient agent. The cost of reordering the information sent in the source agent on its arrival at the destination agent is high in computation time and memory terms.

To avoid this cost of reordering the data packets, it is desirable, that between a source agent and a recipient agent having to exchange ordered information, the transmission path of this information is always the same.

A stream is a set of information having to be transmitted without the order being altered between a source agent and a recipient agent. For a given source agent and a given recipient agent, there can be a number of data packet streams.

Normally, the header of a data packet includes the address of the source agent and the address of the recipient agent, and is used to determine the identifier of the stream to which the packet belongs. In a network with static routing, the routing depends solely on the stream identifiers.

When dynamic routing is implemented, the cost of reordering the packets corresponds mainly to the quantity of data that needs to be stored before the right packet can be sent to its destination, given the disorder that can be generated by the network. Such operation with a final reordering stage is normally simpler for setting up the routing at the nodes of the network, but generates a high memory cost overhead.

Networks with static routing are easier to design and use, because the architecture is defined from the outset, and simple routing tables are sufficient for their implementation.

However, such networks need to be over-engineered, because, since the data transmission paths are fixed, it is not possible to adapt them according to the state of the traffic. It is therefore necessary to engineer the links according to the worst possible scenario, even if statistically these links are little used.

Such networks are, for example, described in the documents “IEEE Communication magazine, volume 28 No. 10, October 89 Distributed Dynamic Routing Schemes, Key et al p 54-58, 63-64” and “Electronics and communication in Japan Part 1 volume 72 No. 11 November 89, Comparison of Stability for Various Routing-Procedures in Circuit-Switched Networks, Yokohira et al, p 43-51”.

One object of the invention is to propose a system for the static routing of streams of data packets in an interconnect network, enabling such over-engineering to be avoided, and at low cost.

Thus, according to one aspect of the invention, a system for the static routing of streams of data packets in an interconnect network is proposed. The system comprises at least one sending element, one receiving element, and one link set of unidirectional communication links linking said sending element to said receiving element. Said sending element is designed to send data packets to said receiving element via said link set. The system also comprises means of detecting a stream identifier of a data packet, and dynamic routing management means, designed to keep the order of output of the data packets of one and the same stream from said receiving element identical to the order of arrival of said packets at said sending element.

The system keeps the order of the data packets of one and the same stream the same, avoiding the cost overhead of a reordering of the packets on their arrival.

In a preferred embodiment, said dynamic routing management means include selection means for selecting the number N of data packets at the input of the sending element.

Thus, the routing is done simultaneously for a number N of data packets.

In other words, the dynamic routing management means include selection means for applying arbitration to the data packets to be transferred.

Advantageously, said dynamic routing management means include:
buffer memories associated in a one-to-one correlation with the links of said link set,
N sets of control means, the control means of a set being associated in a one-to-one correlation with said buffer memories, and designed to store, in the associated buffer memory, the stream identifiers of the packets currently being transferred in the corresponding link, and to eliminate, from said associated buffer memory, the stream identifiers with no packets currently being transferred in the corresponding link,
N sets of comparators, the comparators of a set being associated in a one-to-one correlation with the basic elements of said buffer memories, and designed to determine whether a packet to be transmitted has a stream identifier included in one of said buffer memories.

A basic element of said buffer memories corresponds to a memory location of a buffer memory used to store a stream identifier.

The system makes it possible, when transmitting a data packet of a stream in the link set, to determine whether another data packet of the same stream is currently being transferred over a link of the circuit group, and in this case, to determine the link on which this transfer is taking place.

At a given instant, a data packet of a stream is currently being transferred in no more than one link of said link set.

In an embodiment, said dynamic routing management means are designed, when one of said comparators determines the presence of the stream identifier of a selected packet in the associated buffer memory, to route said selected data packet over the corresponding link of the link set.

In other words, the data packets of one and the same stream are transferred over the same link of the link set, which ensures that the order of output of the data packets of one and the same stream from the receiving element is the same as the order in which these data packets are received by the sending element.

In another embodiment, said dynamic routing management means are designed to queue a selected data packet for routing, as long as one of said comparators determines the presence of the stream identifier of said packet in said associated buffer memory.

In other words, when a data packet of a stream is currently being transferred over a link of the circuit group, and another data packet of the same stream is selected, the dynamic routing management means queue it until the other data packet of the same stream has been transferred. Thus, when the data packet is to be transferred, the dynamic routing management means can transfer it over any one of the links of the link set, and take account of the traffic on the different links of the link set. This embodiment makes it possible to fairly distribute the data traffic load over all the links of the link set.

Furthermore, said dynamic routing management means are designed to route a selected data packet, when none of said comparators determines the presence of the stream identifier of said packet in said associated buffer memory, according to packet information different from the stream identifier.

The management of the traffic on the links of the link set can then be optimized according to particular criteria.

For example, said packet information different from the stream identifier includes an identifier of a memory area and/or an identifier of operations to be performed. This is particularly useful when the receiving element is a DRAM-type random access memory.

In an embodiment, said dynamic routing management means are designed to route a selected data packet according to the bit rate available in the links of said link set, when none of said comparators determines the presence of the stream identifier of said packet in said associated buffer memories.

The bit rate available in the various links of the link set is then taken into account.

For example, said links of the link set are asynchronous or mesochronous links for linking two locally synchronous subsystems.

In an embodiment, at least one link of said link set includes means of changing the format of the transferred data.

This is used to avoid data gaps in the write requests. The term “gap” is used to mean an interval between two clock pacing pulses that is not used to transmit data.

According to another aspect of the invention, a method for the static routing of streams of data packets in an interconnect network is also proposed. A link set of unidirectional communication links linking a sending element to a receiving element, and said sending element being designed to send data packets to said receiving elements via said link set:
a stream identifier of a data packet is detected, and
a dynamic packet routing is managed in said link set, so as to keep the order of output of data packets of one and the same stream from said receiving element identical to the order of arrival of said packets at said sending element.

Advantageously, a number N of data packets is selected at the input of the sending element.

In an embodiment, the dynamic routing is managed by using buffer memories associated in a one-to-one correlation with said links of said link set. Said buffer memories are controlled by storing in the associated buffer memory the stream identifiers of the packets currently being transferred in the corresponding link and, stream identifiers with no packets currently being transferred in the corresponding link are eliminated from said associated buffer memory, and whether a packet to be transmitted has a stream identifier included in one of said buffer memories is determined.

In an embodiment, a selected data packet is routed, when the presence of the stream identifier of said packet is determined in one of said buffer memories, over the link corresponding to said buffer memory.

When the stream identifier of said data packet is detected in none of said buffer memories, the choice of the link of the link set to transfer the data packet can be free.

In another embodiment, a selected data-packet is queued for routing as long as the presence of the stream identifier of said packet is detected in one of said buffer memories.

Furthermore, a selected data packet is routed, when the stream identifier of said packet is detected in none of said buffer memories, according to packet information different from the stream identifier.

For example, said packet information different from the stream identifier includes an identifier of a memory area and/or an identifier of operations to be performed.

Advantageously, a selected data packet is routed, when the stream identifier of said packet is detected in none of said buffer memories, according to the bit rate available in the links of said link set.

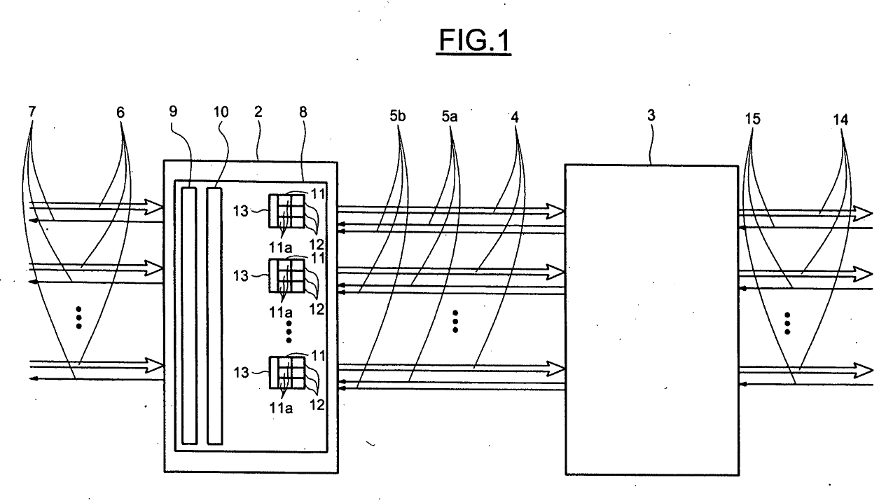

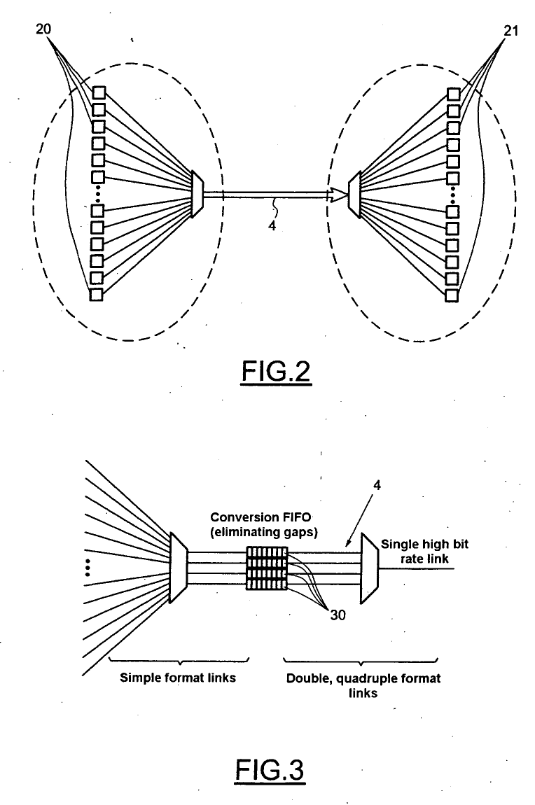

Other objects, characteristics and advantages of the invention will become apparent from reading the description that follows, of a few by no means limiting examples, given with reference to the appended drawings, in which:
FIG. 1 is a block diagram of an embodiment of a system according to one aspect of the invention; and
FIGS. 2, 3 and 4 are block diagrams of other embodiments of a system according to one aspect of the invention;

As illustrated in FIG. 1, the system 1 comprises a sending element 2 and a receiving element 3. The sending element 2 is a switching element.

A set of unidirectional communication links 4 links the sending element 2 and the receiving element 3.

Each unidirectional communication link of the link set 4 has an associated unidirectional flow control link 5a linking the receiving element 3 and the sending element 2. In other words, the system includes a plurality of pairs of links in opposite directions linking the sending element 2 and the receiving element 3.

The sending element 2 includes unidirectional input links 6, each provided with a unidirectional flow control link 7 in the opposite direction.

The sending element 2 includes a dynamic routing management module 8 designed to manage the routing of the data packets to be transmitted from the sending element 2 to the receiving element 3 via the link set 4 of unidirectional communication links.

The dynamic routing management module 8 can, for example, be implemented by software or a dedicated circuit.

The dynamic routing management module 8 includes a module 9 for detecting a stream identifier and a module 10 for selecting data packets to be transmitted.

The detection module 9 and the selection module 10 can, for example, be respectively implemented by software or a dedicated circuit.

In the rest of the description, it is assumed that the selection module 10 selects a single data packet, but, of course, the invention also relates to a selection module selecting a number of data packets simultaneously.

The dynamic routing management module 8 furthermore includes buffer memories 11 associated in a one-to-one correlation with the unidirectional communication links of the. link set 4. The buffer memories are, in this example, organized in a FIFO (first-in, first-out) type queue.

In other words, each unidirectional communication link of the link set 4 is associated with a single queue 11, and a queue 11 is associated with a single unidirectional communication link of the link set 4.

Each unidirectional communication link of the link set 4 has an associated unidirectional link 5b for control by the receiving element 3 of the associated queue 11. Thus, the receiving element 3 can report on the arbitration performed on a data packet transferred over a link of the link set 4, so that the associated queue 11 can eliminate the stream identifier of the packet from the queue 11.

Furthermore, comparators 12 are associated in a one-to-one correlation with the basic elements 11a of the queues 11, and control modules 13 are associated in a one-to-one correlation with the queues 11. The sending element 2 includes the comparators 12 and the control modules 13.

A basic element of a queue 11 is a memory location used to store a stream identifier.

For embodiments in which the selection means 10 select a number of data packets to be processed simultaneously, for each selected packet, comparators 12 are associated in a one-to-one correlation with the basic elements of the queues 11, and control modules 13 are associated in a one-to-one correlation with the queues 11.

The comparators 12 and the control modules 13 can, for example, be respectively implemented by software or a dedicated circuit.

The sending element 2 can be a source agent of the network associated with a switching element. The receiving element 3 can be a switching element associated with a recipient element.

A source agent can be a message initiator, a recipient agent can be a message destination, and a switching element can be a message transmission intermediary.

The receiving element 3 includes unidirectional output links 14, each provided with a unidirectional flow control link 15 in the opposite direction.

Since the sending element 2 is a switching element, it includes output links, not shown in FIG. 1, to transmit data to other switching elements or other recipient elements than the receiving element 3.

In the routing tables, the link set is considered as a single link, so, as seen from the routing tables, the routing is considered to be static.

The data packets belonging to various data streams arrive at the sending element 2 via the input links 6. A data stream is a set of data transmitted from a source element to a recipient element. The data packets belonging to one and the same data stream include an identical stream identifier.

The stream identifier detection module 9 is designed to determine the stream identifier of the packets arriving at the sending element 2.

The selection module or arbitration module 10 is designed to select at least one data packet at the input of the sending element 2, to be processed by the dynamic routing management module 8.

The selection module 10 operates conventionally.

For each data packet that is selected and whose stream identifier is known by the detection module 9, the comparators 12 determine whether there is a queue 11 including the stream identifier of the packet. In other words, the comparators 12 are used to determine if there is a packet belonging to the same data stream as a packet to be transferred, that is currently being transferred over a link of the link set 4, and, where appropriate, to identify the link being used.

If a comparator 12 is used to determine that a data packet, belonging to the same stream as the packet to be processed, is currently being transferred over the corresponding link associated with the comparator, a number of processes on this packet are possible, according to the operation of the dynamic routing management module 8, dependent on the implementation of the dynamic routing management module 8.

In a first embodiment, the dynamic routing management module 8 routes the selected data packet over the link of the link set 4 having the associated queue 11 that includes the stream identifier of the data packet. Thus, the order of transfer of the data packets of one and the same stream is respected.

In another embodiment, when a comparator 12 detects, for a selected data packet, another data packet of the same stream currently being transferred over the corresponding link, the dynamic routing management module 8 queues the selected data packet for routing as long as the data packet currently being transferred and having the same stream identifier is being transferred.

Thus, the order of transfer of the data packets of one and the same stream is respected.

The control modules 13 are each designed to store, in their associated queue 11, the stream identifier of a data packet transferred by the dynamic routing management module 8 over the corresponding link, and to eliminate from the associated queue the identifier of a data packet ending its transfer in the corresponding link of the link set 4.

For a selected data packet, when no comparator 13 determines the presence of another data packet of the same stream currently being transferred over a link of the link set 4, after having or not after having been queued, a number of embodiments of the dynamic routing management module 8 are possible.

In a first embodiment, the selected data packet is routed according to packet information different from the stream identifier, for example, an identifier of a memory area and/or an identifier of operations to be carried out. In practice, for example, the various unidirectional communication links of the link set. 4 can be associated with determined memory areas of 'the receiving element 3.

In another embodiment, the dynamic routing management module 8 routes the selected data packet according to the bit rate available in the unidirectional communication links of the link set 4. In other words, the dynamic routing management module 8 routes the selected data packet in the link of the link set 4 having the highest available bit rate.

Data packets belonging to one and the same data stream can originate only from one and the same unidirectional input link 6. Therefore, when a data packet of this stream has been assigned to a unidirectional communication link of the link set 4, and the data packet has not been processed by the selection or arbitration module 10, there cannot be another request for a data packet belonging to this stream.

In practice, such a request would necessarily emanate from the same unidirectional input link 6, and the latter remains unavailable as long as the data packet remains queued. There cannot therefore be two data packets of one and the same stream queued for routing in the system. However, when it is detected that a data packet of a stream is currently being transferred in a unidirectional communication link of the link set 4, this means that a data packet of the same stream has been sent by the sending element 2, but it has not yet been subjected to arbitration by the receiving element 3.

When a number of packets are processed simultaneously, each buffer memory 11 includes a comparator and an associated control module for each of the packets processed simultaneously.

The number of input links 6 of the sending element 2, the number of links of the link set 4, and the number of output links of the receiving element 3 are independent of each other.

In FIG. 2, numerous agents 20 have to communicate with numerous agents 21. Each agent 20, taken separately, transfers a low data rate, but the sum of the data rates of all of the agents 20 is high. The invention makes it possible to avoid having a number of links in parallel and assigning each of the parallel links a subgroup of agents. In practice, the link set makes it possible to avoid the presence of a queue for each agent 20 for storing a complete data packet before being able to send it, and this in order to avoid gaps in the messages, because each stream has its link of the link set dedicated at a given instant.

The routing table internal to the link set is constructed dynamically, which means that it can be adapted according to the different rates of data transferred over the network.

The choice of a link of the link set depends neither on the sending element, nor on the recipient element, but respects the order of the data packets of a stream.

The invention applies to all the data packet transport modes, for example the synchronous, asynchronous or mesochronous transport modes.

In the example of FIG. 2, each sending agent transmits data packets with wide. gaps between the data packets. In the links of the link set 4, a number of streams are present, and a data gap between the packets of one and the same stream can be used by other streams, so enabling the use of the available bandwidth to be optimized.

FIG. 3 illustrates a link set including queues 30, enabling the size of the words used to be changed. The link set 4 can be used to write to the queues 30, so that the data gaps can be eliminated at low bit rates, and to read from said queues 30 at high bit rates. The dynamic routing in the links of the link set 4 makes it possible to distribute the data traffic uniformly over the various queues 30.

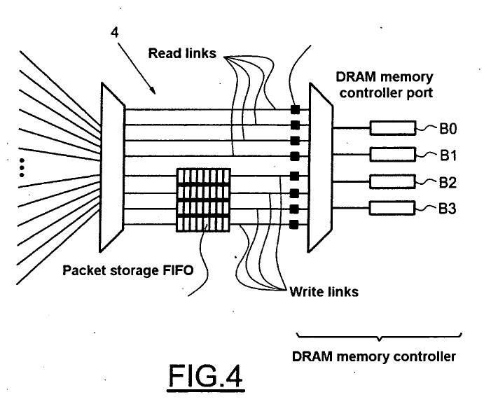

In FIG. 4, the receiving element is a DRAM-type memory controller, comprising four memory portions or banks B0, B1, B2 and B3. Four links of the link set 4 are write links, each provided with a queue for storing packets, because a DRAM-type memory controller does not include flow control means. The link set 4 also includes four read links for reading data.

It is then possible on the one hand to separate the read access requests from the write access requests, and on the other hand to be able to distribute the various requests over the different memory banks BO, B1, B2 and B3.

Unlike the static routing for each bank and access type, the order of execution of the requests in the streams is retained, and it is then pointless to order the information output from the DRAM controller. The invention then allows the advantages of a static routing for each bank, without the reordering drawbacks.

The invention makes it possible to optimize the use of the available bit rate between two nodes of the network, without requiring the data packets to be reordered when they arrive at their destination element.

1. System for the static routing of streams of data packets in an interconnect network, comprising:
at least one sending element, one receiving element, and one link set of unidirectional communication links linking said sending element to said receiving element said sending element being designed to send data packets to said receiving element via said link set,
means of detecting a stream identifier of a data packet, and
dynamic routing management means, designed to keep the order of output of the data packets of one and the same stream from said receiving element identical to the order of arrival of said packets at said sending element.

2. System according to claim 1, wherein said dynamic routing management means comprises selection means for selecting a number N of data packets at the input of the sending element.

3. System according to claim 2, wherein said dynamic routing management means comprises:
buffer memories associated in a one-to-one correlation with the links of said link set,
N sets of control means, the control means of a set being associated in a one-to-one correlation with said buffer memories, and designed to store, in the associated buffer memory, the stream identifiers of the packets currently being transferred in the corresponding link, and to eliminate, from said associated buffer memory, the stream identifiers with no packets currently being transferred in the corresponding link, and
N sets of comparators, the comparators of a set being associated in a one-to-one correlation with the basic elements of said buffer memories, and designed to determine whether a packet to be transmitted has a stream identifier included in one of said buffer memories.

4. System according to claim 1 wherein said dynamic routing management means are designed, when one of said comparators determines the presence of the stream identifier of a selected packet in the associated buffer memory, to route said selected data packet over the corresponding link of the link set.

5. System according to claim 1. wherein said dynamic routing management means are designed to queue a selected data packet for routing, as long as one of said comparators determines the presence of the stream identifier of said selected packet in said associated buffer memory.

6. System according to claim 1. wherein said dynamic routing management means are designed to route a selected data packet, when none of said comparators determines the presence of the stream identifier of said packet in the associated buffer memory, according to packet information different from the stream identifier.

7. System according to claim 6, wherein said packet information different from the stream identifier includes an identifier of a memory area and/or an identifier of operations to be performed.

8. System according to Claim 1, wherein said dynamic routing management means are designed to route a selected data packet according to the bit rate available in the links of said link set, when none of said comparators determines the presence of the stream identifier of said packet in said associated buffer memories.

9. System according to claim 1, wherein said links of the link set are asynchronous or mesochronous links for linking two locally synchronous subsystems.

10. System according to claim 1, wherein at least one link of said link set includes means of changing the format of the transferred data.

11. Method for the static routing of streams of data packets in an interconnect network, the interconnect network comprising: a link set of unidirectional communication links linking a sending element to a receiving element, and said sending element being designed to send data packets to said receiving element via said link set, the method comprising:
detecting a stream identifier of a data packet, and
managing a dynamic packet routing in said link set so as to keep the order of output of data packets of one and the same stream from said receiving element identical to the order of arrival of said packets at said sending element.

12. Method according to claim 11, wherein a number N of data packets is selected at the input of the sending element.

13. Method according to claim 12, wherein the dynamic routing is managed:
by using buffer memories associated in a one-to-one correlation with said links of said link set;
by controlling said buffer memories by storing in the associated buffer memory the stream identifiers of the packets currently being transferred in the corresponding link and, by eliminating, from said associated buffer memory, the stream identifiers with no packets currently being transferred in the corresponding link; and
by determining whether a packet to be transmitted has a stream identifier included in one of said buffer memories.

14. Method according to claim 11, wherein a selected data packet is routed, when the presence of the stream identifier of said packet is determined in one of said buffer memories, over the link corresponding to said buffer memory.

15. Method according to claim 11, wherein a selected data packet is queued for routing as long as the presence of the stream identifier of said packet is detected in one of said buffer memories.

16. Method according to claim 11, wherein a selected data packet is routed, when the stream identifier of said packet is detected in none of said buffer memories, according to packet information different from the stream identifier.

17. Method according to claim 16, wherein said packet information different from the stream identifier includes an identifier of a memory area and/or an identifier of operations to be performed.

18. Method according to claim 11, wherein a selected data packet is routed, when the stream identifier of said packet is detected in none of said buffer memories, according to the bit rate available in the links of said link set.
